(19) United States
(12) Patent Application Publication
(10) Pub. No.: US 2026/0180478 A1
(43) Pub. Date: Jun. 25, 2026

(54) AIRCRAFT TURBINE ENGINE COMPRISING AN ELECTRIC MOTOR COMPRISING A DEVICE FOR CORRECTING A PRECESSION MOVEMENT AND ASSOCIATED METHOD

(71) Applicant: SAFRAN AIRCRAFT ENGINES, Paris (FR)

(72) Inventors: Romain TRUCO, MOISSY-CRAMAYEL (FR); Frédéric MONTIN, MOISSY-CRAMAYEL (FR); Pierre-Alain Jean Philippe REIGNER, MOISSY-CRAMAYEL (FR); Alexandre Jean-Marie TAN-KIM, MOISSY-CRAMAYEL (FR)

(21) Appl. No.: 19/123,175

(22) PCT Filed: Oct. 23, 2023
(86) PCT No.: PCT/EP2023/079431

§ 371 Date: Apr. 22, 2025

(30) Foreign Application Priority Data
Oct. 24, 2022 (FR) FR2210992

(51) Int. Cl. H02P 9/00; F01D 15/10; F01D 21/00; H02K 7/18

(52) U.S. Cl. CPC H02P 9/006; F01D 15/10; H02K 7/1823; H02P 9/009; F01D 21/003; F05D 2220/323; F05D 2220/76

(57) ABSTRACT

An aircraft turbine engine including at least a propulsion shaft and an electric motor. A rotor is rigidly connected to the propulsion shaft. The electric motor includes at least three power channels, a control device designed to determine a control parameter for each power channel on the basis of a control command, and a correction device designed to correct a precession movement of the rotor relative to the stator. The correction device being designed to determine the control command of the control device from a setpoint command and a precession level. The control command being designed to generate a global magnetic force opposing the precession movement of the rotor so as to damp said movement.

### TECHNICAL FIELD

The present invention relates to the field of electric motors, in particular those on board an aircraft turbine engine. The invention is particularly advantageous for an electric motor driven in rotation by a propulsion shaft of an aircraft turbine engine to generate electrical power.

The invention also applies to an electric motor used in motor operation.

The climate change is a major concern for many legislative and regulatory members around the world. Various restrictions on carbon emissions have been, are being or will be adopted by various states. In particular, an ambitious standard applies both to new types of aircrafts and to those already in circulation, requiring the implementation of technological solutions so as to bring them into line with current regulations. For several years now, the civil aviation has been working to help combat climate change.

The technological research efforts have already led to very significant improvements in the environmental performance of the aircrafts. The Applicant takes into account the impacting factors in all phases of design and development to obtain aeronautical elements and products that consume less energy, are more environmentally friendly and whose integration and use in civil aviation have moderate environmental consequences with the aim of improving the energy efficiency of the aircrafts.

Consequently, the Applicant is constantly working to reduce its negative impact on the climate through the use of virtuous development and manufacturing methods and processes that minimize greenhouse gas emissions as much as possible in order to reduce the environmental footprint of its business.

This sustained research and development work concerns both new generations of aircraft engines and the development of electric propulsion technologies.

It is known in the prior art to mount an electric motor on a propulsion shaft of an aircraft turbine engine, for example a fan shaft. In particular, the electric motor is configured to operate in a generator mode so as to collect mechanical power from the propulsion shaft in order to generate electrical power. The electric motor is also configured to operate in a motor mode so as to provide mechanical power to the propulsion shaft by collecting electrical power, for example, from an electrical battery.

With reference to FIG. 1, an electric motor 101 is shown schematically, comprising a stator 102 mounted stationary in a turbine engine and a rotor 103 secured to a propulsion shaft of turbine engine. The rotor 103 is mounted so that it may rotate relative to the stator 102. In this example, the rotor 103 rotates clockwise R+ relative to an electric motor axis X. In a known manner, the stator 102 comprises power channels C1-C4, distributed around the periphery of the stator 102, which interact magnetically with the rotor 103. Preferably, the power channel C1-C4 is in the form of a stator star.

Theoretically, during the generation of electrical power, each power channel C1-C4 generates a resistive magnetic force F1-F4 on the rotor 103 which opposes the rotation of the rotor 103.

In theory, the rotor 103 remains perfectly aligned with the electric motor axis X. In practice, a propulsion shaft of a turbine engine undergoes vibrations during its rotation about the electric motor axis X which induce a precession movement on the rotor 103. Such precession movement may lead to loss of performance and even premature wear of the turbine engine. With reference to FIG. 2, a precession movement of the rotor 103 between time instants t1, t2, t3 is shown. In this example, the precession movement P+ is clockwise, but of course it may also be anti-clockwise.

To reduce the precession movement, it is known in the prior art to provide a damping film, referred to the person skilled in the art as a “Squeeze Film Damper” or SFD. A squeeze film damper, positioned between the rotor 103 and the stator 102, allows vibrations to be damped passively, in particular at the level of a bearing of a turbine engine. Thus, the squeeze film damper exerts a damping force which depends mainly on the following parameters: the eccentricity of the rotor 103, the speed of rotation of the rotor 103, the characteristics of the squeeze film damper (viscosity, etc.) and the boundary conditions (supply, sealing, etc.). In practice, the damping film is dimensioned so as to damp a predetermined vibration mode of the rotor 103 as effectively as possible. It is therefore not very effective on the other vibration modes present in the operating range of the electric motor 101, which is a disadvantage.

The invention aims to eliminate at least some of these disadvantages.

In the technical field of motorbikes, the patent application WO03034573A1 teaches a three-phase electric motor of the “start power generator” type with windings dedicated to starting.

### PRESENTATION OF THE INVENTION

The invention relates to an electric motor, in particular for an aircraft turbine engine, comprising:
A stator comprising at least three power channels and a rotor configured to interact magnetically with the power channels,
The electric motor being configured, on the one hand, to operate in a generator mode in order to collect mechanical power from the rotor to generate electrical power and to operate, on the other hand, in a motor mode in order to consume electrical power to generate mechanical power and drive the rotor,
A control device configured to determine a control parameter for each power channel as a function of a control command, each control parameter defining the currents circulating in a power channel, each power channel generating a magnetic force on the rotor which is a function of its control parameter, the assembly of the magnetic forces applied by the power channels on the rotor defining an overall magnetic force, and
A correction device configured to correct a precession movement of the rotor relative to the stator, the correction device being configured for:
   determining the precession level of the rotor relative to the stator.
   determining the control command for the control device from a setpoint command and from the precession level, the control command being configured to generate an overall magnetic force opposing the precession movement of the rotor so as to damp it.

Thanks to the invention, the correction device allows to modify the control command of the power channels, used to generate a mechanical torque or to generate electrical power, in order to correct a precession movement of the rotor. This eliminates the need for additional means to act on the rotor, reducing mass and overall dimension requirements. In addition, a correction device of this type provides a dynamic damping that may meet a variety of vibrations. Its field of application is therefore broader than that of a squeeze film damper efficient only for a few vibratory modes. Advantageously, the damping intensity may be precisely adjusted. The damping is active, not passive.

Finally, the electric motor allows a damping to be achieved while continuing to perform its primary function of generating a mechanical torque or electrical power, which is very advantageous.

Preferably, the correction device is configured, during operation in generator mode, to determine a control command consisting of injecting or modulating a current into only one power channel at a given instant, the other power channels being configured to collect currents at the given instant.

Thus, in the absence of current circulating in the power channel, a current is injected into the power channel to perform damping. In the presence of a current circulating in the power channel, the current circulating in the power channel is modulated to achieve a damping, for example, which is increased punctually.

A correction device of this type provides a damping while continuing to perform its primary function of generating electrical power. The command of a single power channel is modified, with only a slight reduction in efficiency.

Preferably, the correction device is configured to determine a control command consisting of successively injecting or modulating a current into a plurality of power channels so as to generate an overall rotating magnetic force opposing the precession movement over time.

An overall rotating magnetic force allows to effectively oppose a precession movement while maximizing the efficiency of the electric motor.

Preferably, the correction device is configured to determine a control command consisting of injecting or modulating a current according to a phase advance with respect to the precession movement of the rotor. A phase advance correction allows an overall magnetic force to be applied which directly opposes the precession movement, providing optimum damping.

Preferably still, the correction device is configured, during operation in motor mode, to determine a control command consisting of collecting or modulating a current in only one power channel at a given instant, the other power channels being configured to inject currents at the given instant. Generally speaking, the motor operation may be deduced from the generator operation. In the presence of a current circulating in the power channel, the current circulating in the power channel is modulated to produce a damping, for example, punctually lowered.

According to one aspect of the invention, the stator comprises at least one pair of diametrically opposed power channels. This allows a magnetic force to be applied along an axis orthogonal to the alignment axis of the power channels in a pair. The direction of the overall magnetic force is thus determined rigorously.

Preferably, the stator comprises at least four power channels angularly spaced apart by 90°. This allows the magnetic force to be precisely adjusted to position the rotor relative to the stator. This provides high performance damping.

The invention also relates to an aircraft turbine engine comprising at least one propulsion shaft and an electric motor as presented above, whose rotor is rigidly connected to the propulsion shaft. An integration in an aircraft turbine engine is relevant because a propulsion shaft is subject to numerous vibration modes. An electric motor of this type may generate mechanical torque/electrical generation while damping vibrations.

Preferably, the propulsion shaft is secured to a fan comprising a plurality of fan vanes. The fan is mounted in a fan casing. Mounting an electric motor on a fan shaft is advantageous because a precession movement increases wear and presents a hazard to aircraft passengers.

Preferably, the rotor is mounted at the free ends of the fan vanes, the stator being mounted on the fan casing. This integration allows to correct a significant precession movement at the free ends of the fan vanes, given the bending forces applied to the fan shaft, which amplify the precession movement. This also allows several power channels to be used for progressive damping.

The invention relates to a method for monitoring an electric motor as previously presented, a setpoint command being defined, the method comprising steps consisting in:
determining a precession level of the rotor relative to the stator,
determining the control command of the control device from a setpoint command and the precession level, the control command generating an overall magnetic force opposing the precession movement of the rotor so as to damp it.

Preferably, the step consisting in determining the level of precession of the rotor is only implemented when the vibrations measured on the propulsion shaft exceed a predetermined threshold. This allows to maximize the use of the electric motor for its primary function (generator or motor).

Preferably, the monitoring method comprises steps consisting in:
recording the overall magnetic forces generated overtime and
estimating the state of wear of the turbine engine from the overall magnetic forces recorded over time.

Advantageously, by following the evolution of the overall magnetic forces applied, we estimate the need for correction and, consequently, the state of wear of the turbine engine. If the overall magnetic force applied becomes too high, a step of maintenance of the turbine engine must be carried out.

### PRESENTATION OF FIGURES

The invention will be better understood on reading the following description, given by way of example, with reference to the following figures, given by way of non-limiting examples, wherein identical references are given to similar objects.

FIG. 1 is a schematic representation of an electric motor and the magnetic forces applied to the rotor.

FIG. 2 is a schematic representation of a precession movement of a rotor of an electric motor.

FIG. 3 is a schematic representation of an aircraft turbine engine equipped with an electric motor.

FIG. 4 is a schematic representation of an electric motor according to one embodiment of the invention.

FIG. 5 is a representation of a plurality of control modules for a control device to control each power channel.

FIG. 6 is a schematic representation of a first control module of the control device receiving switching orders from a first switching member.

FIG. 7 is a schematic representation of the determination of switching orders by the first switching member.

FIG. 8 is a schematic representation of the electric motor of FIG. 4 and the magnetic forces applied to the rotor in the absence of a precession movement.

FIG. 9 is a schematic representation of the electric motor of FIG. 4 and of the magnetic forces applied to the rotor having a precession movement at a first instant.

FIG. 10 is a schematic representation of the electric motor in FIG. 4 and the magnetic forces applied to the rotor having a precession movement at a second instant.

FIG. 11 is a schematic representation of the steps in a method for monitoring an electric motor.

FIG. 12 is another schematic representation of the electric motor shown in FIG. 4 and the magnetic forces applied to the rotor having a precession movement at a first instant.

FIG. 13 is a schematic representation of a turbine engine comprising an electric motor mounted on the periphery of a fan.

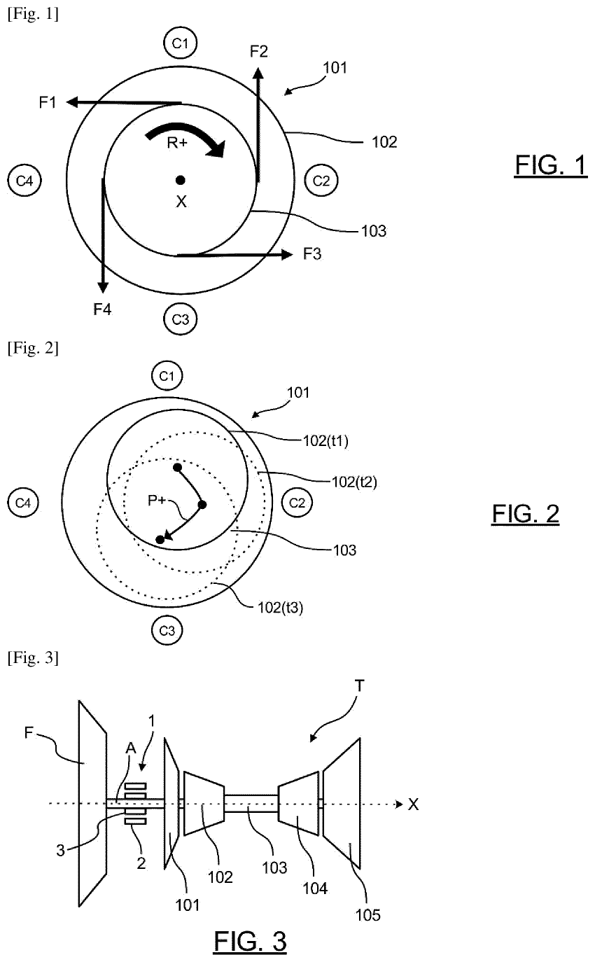

It should be noted that the figures set out the invention in detail in order to implement the invention, said figures of course being able to be used to better define the invention if necessary.

### DETAILED DESCRIPTION OF THE INVENTION

The invention will be presented for an electric motor for an aircraft turbine engine. Such an application is particularly advantageous given that an aircraft turbine engine is subject to vibration. However, the invention is applicable to any electric motor, particularly in the industrial field.

In this example, with reference to FIG. 3, an aircraft turbine engine T is shown comprising at least one propulsion shaft A on which an electric motor 1 is mounted. Preferably, the propulsion shaft A is a fan shaft F, in particular a low-pressure shaft of a dual-body turbine engine T comprising a low-pressure shaft A and a high-pressure shaft 103.

In this example, a low-pressure compressor 101, a high-pressure compressor 102, a high-pressure turbine 104 and a low-pressure turbine 105 are also shown schematically in FIG. 3. The low-pressure propulsion shaft A connects the low-pressure compressor 101 to the low-pressure turbine 105. The high-pressure shaft 103 connects the high-pressure compressor 102 to the high-pressure turbine 104.

Such a propulsion shaft A is susceptible to undergo vibrations during operation which may disturb the rotation of the fan F.

With reference to FIG. 3, the electric motor 1 comprises a stator 2 mounted in a stationary manner in the turbine engine T and a rotor 3 rigidly mounted to the propulsion shaft A, the rotor 3 being mounted so as to rotate relative to the stator 2 about an electric motor axis X. In this example, the electric motor axis X coincides with the axis of the propulsion shaft A. It goes without saying that this may be different.

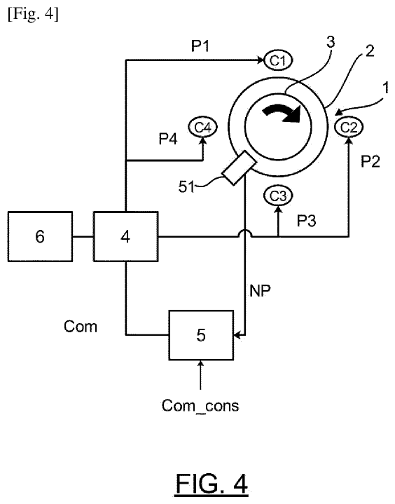

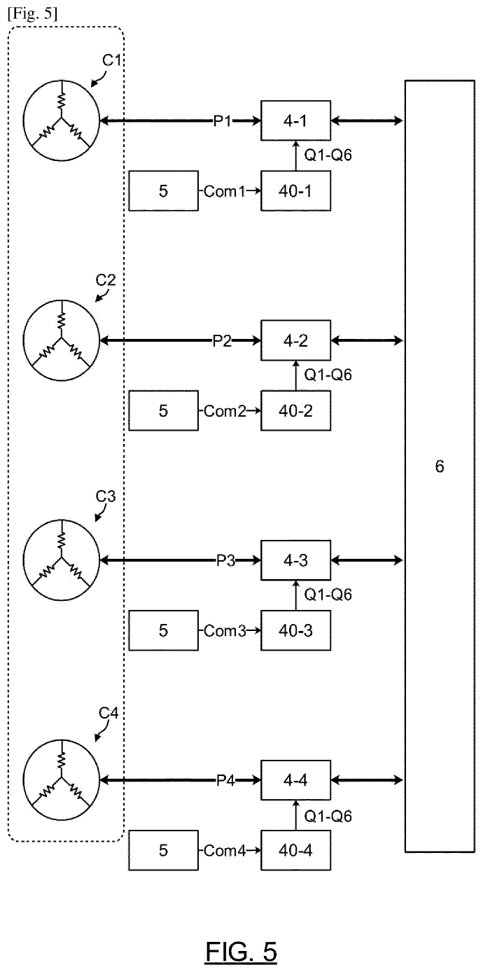

With reference to FIG. 4, the stator 2 comprises four power channels C1-C4. The stator 2 may comprise a different number of power channels, from preferably a number greater than 3. Each power channel C1-C4 is preferably in the form of a winding to circulate a current injected by a control device 4 (presented later) or to collect a current generated by magnetic induction. The use of several power channels C1-C4 allows to increase the redundancy and limits the risk of critical failure. In this example, with reference to FIG. 5, each power channel C1-C4 takes the form of an independent stator star generating three-phase alternating currents during generator operation and receiving three-phase alternating currents during motor operation.

In this embodiment, the stator 2 comprises four power channels C1-C4 angularly spaced apart by 90°. The presence of pairs of diametrically opposed power channels C1-C3, C2-C4 is advantageous, as will be shown below, in order to exert a controlled magnetic force on the rotor 3.

The rotor 3 comprises a plurality of magnetic elements, in particular magnets, in order to interact magnetically with the power channels C1-C4 of the stator 2, in particular inductively.

The electric motor 1 is configured, on the one hand, to operate in a generator mode in order to collect mechanical power from the rotor 3 (and therefore from the fan F) in order to generate electrical power. The electric motor 1 is also configured to operate in motor mode in order to consume electrical power to generate mechanical power and drive the rotor 3 and therefore the fan F.

Generally speaking, with reference to FIG. 3, the electric motor 1 comprises a control device 4 configured to collect, inject or modulate a current in each power channel C1-C4 according to a control command Com. In particular, as mentioned above, the control device 4 may be used to define three-phase currents for each power channel C1-C4.

Hereinafter, “control parameter P1-P4” refers to the three-phase currents commanded by the control device 4 at each power channel C1-C4. In this way, each power channel C1-C4 may be commanded individually as a function of its control parameter P1-P4.

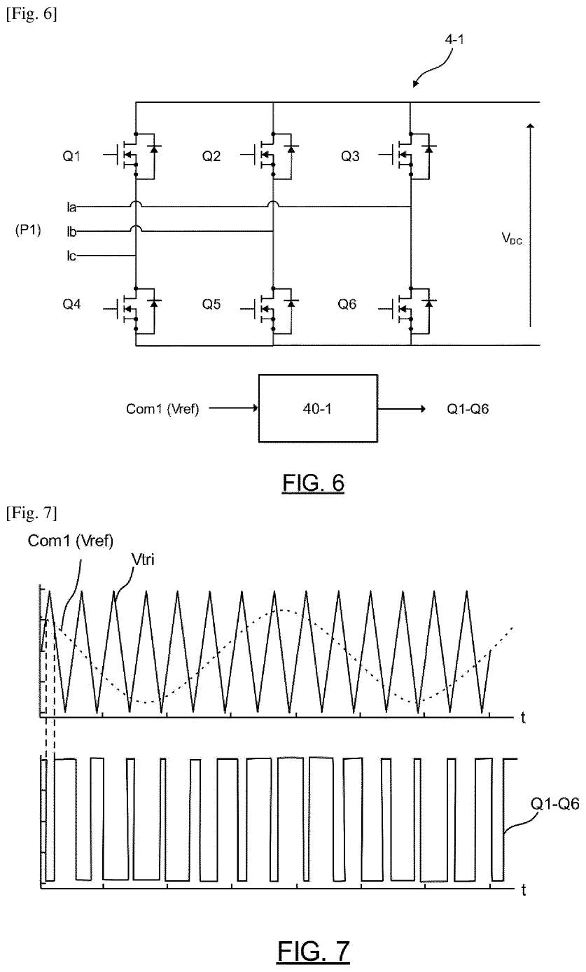

The control device 4 is connected to an electrical network of the aircraft, in particular to an electrical distribution unit 6 being in the form of a distribution bus having a distribution voltage VDC (FIG. 6). The electrical distribution unit 6 is connected to electrical loads to be supplied and/or to electrical sources (batteries, etc.).

According to the invention, the electric motor 1 further comprises a correction device 5 configured to correct a precession movement of the rotor 3 with respect to the stator 2 by modifying the control command Com received by the control device 4. The various elements of the invention will now be presented.

In this example, with reference to FIG. 5, the control device 4 comprises several control modules 4-1, 4-2, 4-3, 4-4 and a plurality of switching members 40-1, 40-2, 40-3, 40-4 configured to control the power channels C1-C4 respectively on the basis of a plurality of elementary commands Com1, Com2, Com3, Com4 from the control command Com. In this example, the control command Com is in the form of a vector.

Preferably, each control module 4-1, 4-2. 4-3, 4-4 is in the form of an AC/DC converter, in particular an inverter, which connects a power channel C1-C4 to the electrical distribution unit 6. With reference to FIG. 6, each control module 4-1.4-2, 4-3. 4-4 comprises a plurality of switches, in particular transistors, which are configured to receive switching orders Q1-Q6 so as to modify the three-phase currents Ia, Ib, Ic supplied to a power channel C1-C4.

Each control module 4-1, 4-2, 4-3, 4-4 is associated with a switching member 40-1, 40-2, 40-3, 40-4 configured to convert an elementary control command Com 1, Com2, Com3, Com4 into switching orders Q1-Q6.

A switching member 40-1.40-2, 40-3. 40-4 determines the switching orders Q1-Q6 by generating pulse width modulation signals (MLI) by comparing a reference voltage Vref, corresponding to an elementary control command Com1, Com2, Com3, Com4, with a triangular reference voltage Vtri as shown in FIG. 7,

As illustrated in FIG. 5, each control module 4-1, 4-2, 4-3, 4-4 of the control device 4 determines, for its power channel C1-C4, a control parameter P1-P4. This means that each power channel C1-C4 may be commanded on an individual basis. Unlike the prior art, wherein all the power channels C1-C4 are used either to inject current or to collect current, the control device 4 allows a hybrid use wherein some power channels C1-C4 are used to inject current while others are used to collect current (modulation of the current in the power channels).

In this example, with reference to FIG. 4, the control device 4 is electrically connected to an electrical distribution unit 6 so as to be able to inject current in motor mode and supply the electrical distribution unit 6 in generator mode.

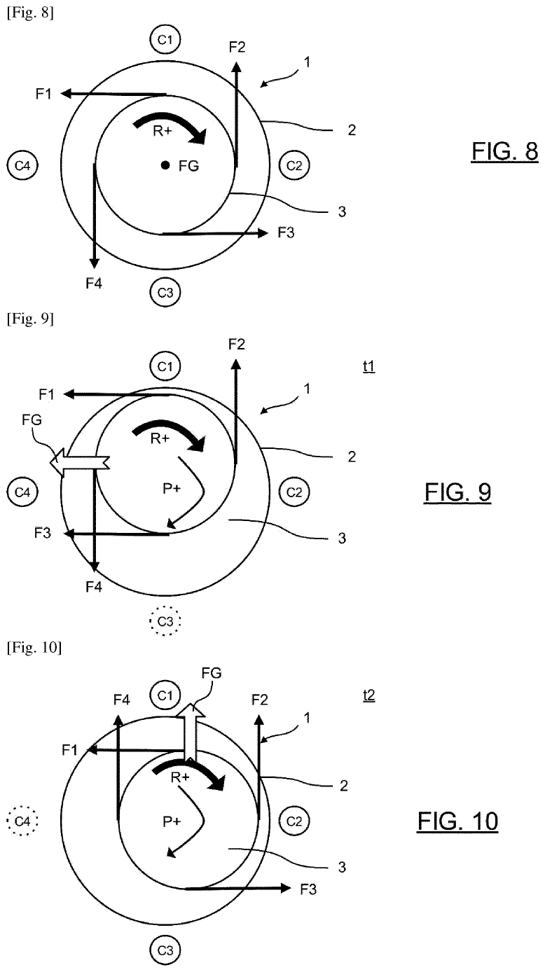

As illustrated in FIG. 8. each power channel C1-C4 generates a magnetic force F1-F4 on the rotor 3 which is a function of its control parameter P1-P4 defined in the control command Com. For example, in generator mode, the magnetic force F1-F4 is a resistive force which opposes the rotation of the rotor 3. Conversely, in motor mode, the magnetic force F1-F4 is a force which accompanies the rotation of the rotor 3. Advantageously, the magnetic force F1-F4 depends on the P1-P4 control parameters of the control command Com. In this way, each magnetic force F1-F4 may be precisely and dynamically parameterized by updating the control command Com, as will be described later.

The assembly of the magnetic forces F1-F4 applied by the power channels C1-C4 on the rotor 3 define an overall magnetic force FG applied to the rotor 3. Conventionally, as illustrated in FIG. 8, the magnetic forces compensate each other so that the overall magnetic force FG is approximately zero. According to the invention, in the absence of precession movement, the overall magnetic force FG is substantially zero.

With reference to FIG. 4, the electric motor 1 comprises a correction device 5 allowing for correcting the precession movement by applying an overall force FG which is a function of the control command Com. By dynamically adapting the control command Com, the precession movement of the rotor 3 is dynamically corrected.

According to the invention, still with reference to FIG. 4, the electric motor 1 comprises a correction device 5 configured to correct a precession movement of the rotor 3 with respect to the stator 2. The correction device 5 is configured to determine a precession level NP of the rotor 3 relative to the stator 2. By precession level NP, is meant in particular a precession direction and a precession intensity, for example, a distance by which the rotor 3 is spaced from the electric motor axis X (eccentricity). Preferably, the precession level NP comprises the current position of the rotor 3 in its precession movement P+, i.e. the precession position. This allows to dynamically correct a precession movement P+ as a function of the precession position. Preferably, the correction device 5 comprises at least one sensor 51 for measuring the eccentricity (also referred to as orbiting) and the direction of rotation. Preferably, the correction device 5 comprises at least two displacement measurement sensors 51 which are out of phase with each other to accurately measure the eccentricity and the direction of rotation. A 90° phase shift is suitable, for example.

The correction device 5 is configured to determine a control command Com from a setpoint command Com_cons at the level of the precession level NP. The control command Com is configured to generate an overall magnetic force FG opposing the precession movement of the rotor 3 so as to damp it.

In other words, the correction device 5 allows to adapt the setpoint command Com_cons so as to allow the setpoint to be partially achieved while correcting the precession movement of the rotor 3 so as to damp it. The control command Com allows to modulate the setpoint command Com_cons to obtain a damping while allowing the electric motor 1 to perform its primary function.

An example of implementation of a method for monitoring an electric motor 1 will be presented with reference to FIGS. 8 to 11.

In this example, the electric motor 1 operates in generator mode and its rotor 3 turns clockwise R+. The control device 4 receives a setpoint command Com_cons which is supplied by a computer (not shown) in the turbine engine T. This setpoint command Com_cons commands each power channel C1-C4 to collect currents (generator mode operation).

In the absence of precession movement, the control command Com is equal to the setpoint command Com_cons. With reference to FIG. 8. each power channel C1-C4 generates a resistive magnetic force F1-F4 on the rotor 3 which is a function of its control parameter P1-P4. In this example, the resistive magnetic forces F1-F4 are of the same value. The result is an overall magnetic force FG that is essentially zero. The rotor 3 is therefore not magnetically moved.

During operation of the turbine engine T, the correction device 5 performs a step E1 consisting of determining the level of precession NP of the rotor 3, in particular, by monitoring the eccentricity of the rotor 3 and the direction of precession via the sensors 51. In this example, with reference to FIGS. 9 and 10, due to the vibrations of the fan shaft A, the rotor 3 has a precession movement. In this example, the precession level NP corresponds to clockwise precession (direct precession P+) with a degree of precession which corresponds to the spacing of the rotor 3 from the electric motor axis X (eccentricity). Preferably, the step of determining E1 the precession level NP of the rotor 3 is only implemented when the vibrations measured on the propulsion shaft A exceed a predetermined threshold. This allows to avoid the need to monitor the precession level NP continuously.

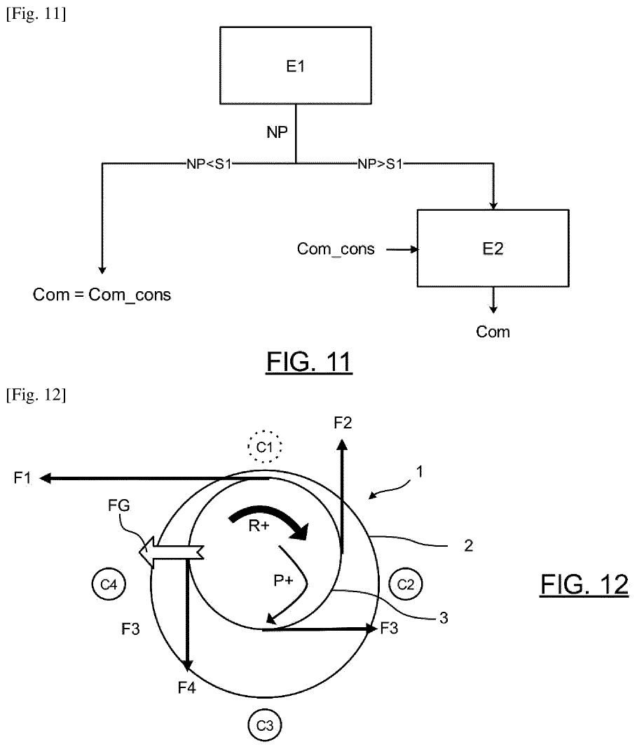

With reference to FIG. 11, if the precession level NP exceeds a predetermined threshold S1, the correction device 5 performs a step E2 consisting of determining a control command Com from the setpoint command Com_cons and the determined precession level NP. In this case, the correction device 5 determines a control command Com to generate an overall magnetic force FG opposing the precession movement of the rotor 3 so as to damp it. In particular, an overall magnetic force FG is applied which opposes clockwise precession with an amplitude which is a function of the eccentricity.

The control command Com may be determined in several ways in order to create an imbalance of magnetic forces and generate a non-zero overall magnetic force FG.

Preferably, the correction device 5 is configured, during operation in generator mode, to inject a correction current into only one power channel C3 at a given instant t, the other power channels C1, C2, C4 being configured to collect currents at the given instant t. The power channels C1-C4 are used in a hybrid way.

By way of example, with reference to FIG. 9, at a first instant t1, the rotor 3 is offset with respect to the electric motor axis X and is located at 12h, i.e. close to the power channel C1. As the rotor 3 follows a clockwise precession movement P+, it will move at a second instant 12 at 3 o'clock towards the power channel C2. In other words, the rotor 3 will move to the right, with reference to FIG. 10,

In this example, still referring to FIG. 9, the correction device 5 has received a setpoint command Com_cons imposing a generator operation wherein each control parameter P1-P4 of a power channel C1-C4 corresponds to a current collection.

To take account of the precession level NP, the correction device 5 determines a control command Com wherein the control parameter P3 is modified to command a current injection on the power channel C3. The result is that the power channel C3 applies a magnetic force F3 which accompanies the rotation of the rotor 3 (in the opposite direction to the setpoint), i.e. in the same direction as the magnetic force F1 applied by the power channel C1. The magnetic forces F2, F4 compensate each other while the magnetic forces F1, F3 add up to generate an overall magnetic force FG which tends to move the rotor 3 to the left, i.e. in the opposite direction to the precession movement P+. As a result, the precession movement P+ of the rotor 3 is damped between instants t1 and t2. The power channels C1, C2, C4 continue to collect current.

Advantageously, a new overall magnetic force FG is determined each time the rotor 3 passes a power channel C1-C3. To this end, with reference to FIG. 10, at the second instant t2, the rotor 3 is offset with respect to the electric motor axis X and is located at 3h, i.e. close to the power channel C2. As the rotor 3 follows a clockwise precession movement, it will move at the third instant t3 at 6 o'clock towards the power channel C3. In other words, the rotor 3 will move downwards.

As already mentioned, the correction device 5 has received a setpoint command Com_cons imposing a generator operation wherein each control parameter P1-P4 of a power channel C1-C4 corresponds to a current collection.

To take account of the precession level NP, the correction device 5 determines a control command Com wherein the control parameter P4 is modified to command a current injection on the power channel C4. As a result, the power channel C4 applies a magnetic force F4 which accompanies the rotation of the rotor 3, i.e. in the same direction as the magnetic force F2 applied by the power channel C2. The magnetic forces F1, F3 compensate each other while the magnetic forces F2, F4 add up to generate an overall magnetic force FG which tends to move the rotor 3 upwards, i.e. in the opposite direction to the precession movement P+. The power channels C1, C2, C3 continue to collect current.

Each time the rotor 3 approaches a power channel C1-C4, the precession movement P+ may be gradually compensated while continuing to collect current in accordance with the setpoint command Com_cons.

Preferably, the correction device 5 is configured to circulate a correction current successively in several power channels C1-C4 so as to generate an overall magnetic force FG opposing the precession movement over time. Preferably, the current injections are carried out successively following the precession movement P+, i.e. clockwise. The overall magnetic force FG is thus rotated to optimally compensate for the precession movement.

Preferably, the correction device 5 is configured to circulate a correction current with a phase advance relative to the precession movement of the rotor 3 so as to modify the trajectory and provide damping. Preferably, the phase advance is determined by feedback or learning. In a particular implementation, the phase advance corresponds to the angular spacing between two consecutive power channels C1-C4.

It goes without saying that an overall magnetic force FG may also be obtained by adjusting the control parameters P1-P4 as illustrated in FIG. 12, for example, by increasing the collection of the first power channel C1 so as to increase the resistive magnetic force F1 in order to obtain an overall magnetic force FG equivalent to that shown in FIG. 9 (modulation of the setpoint current).

Pairs of diametrically opposed power channels C1-C4 make it easier to determine an overall magnetic force FG. When a single power channel is used, the others may continue to perform their collection/injunction function. It goes without saying that several control parameters may be modified in order to generate the desired overall magnetic force FG.

The precession level NG is preferably monitored routinely in order to dynamically adapt the control command Com and the resulting overall magnetic force FG. Preferably, as soon as the precession level NG is below a predetermined threshold, the correction is stopped and the setpoint command Com_cons is no longer modified. Preferably, a control loop is implemented to adapt the correction.

Preferably, the control commands Com are recorded together with the associated rotational speeds of the propulsion shaft A. This allows to determine, at a given speed, whether the overall magnetic force FG is consistent with past corrections. Advantageously, a malfunction of the electric motor may be determined if the overall magnetic force FG is higher than anticipated. Advantageously, it is possible to estimate the state of wear of the turbine engine T by knowing the overall magnetic force FG, which allows predictive maintenance operations to be carried out.

An electric motor 1 operating in generator mode has been presented. However, it goes without saying that the invention applies in a similar way to an electric motor operating in motor mode. To this end, one power channel may collect current while the others inject current.

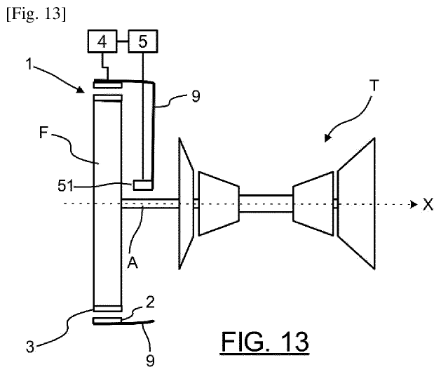

With reference to FIG. 13, an integration of an electric motor at the level of the free ends of the vanes of a fan F of a turbine engine T comprising a fan casing 9 is presented. In this example, the rotor 3 is positioned at the level of the free ends of the vanes of the fan F, while the stator 2 is mounted on the fan casing 9. Such an electric motor 1 allows to collect electrical energy and also drives the fan F in rotation. The positioning of the electric motor 1 allows to correct any orbiting movement of the fan F, which improves the comfort of the passengers in the aircraft. The wear on the turbine engine is also reduced. In this example, the sensor 51 of the correction device 5 is mounted on the fan casing 9. Integrating the electric motor 1 in this way means that a large number of power channels may be used around the periphery of the fan casing 9, allowing a progressive damping.

Thanks to the invention, a precession movement of a rotor of an electric motor may be dynamically damped for various types of vibration. Advantageously, the damping may be carried out during operation of the electric motor, which only slightly affects its efficiency during both motor and generator operation.

1. An aircraft turbine engine comprising at least one propulsion shaft and an electric motor, a rotor of which is rigidly connected to the propulsion shaft, the electric motor comprising:
a stator comprising at least three power channels, the rotor being configured to interact magnetically with the power channels,
the electric motor being configured to operate in a generator mode in order to collect mechanical power from the rotor to generate electrical power and also to operate in a motor mode in order to consume the electrical power to generate mechanical power and drive the rotor,
a control device configured to determine a control parameter for each of the power channels as a function of a control command, each of the control parameters defining currents circulating in the power channel, each of the power channels generating a magnetic force on the rotor which is a function of the control parameter, an assembly of the magnetic forces applied by the power channels on the rotor defining an overall magnetic force, and
a correction device configured to correct a precession movement of the rotor relative to the stator, the correction device being configured for:
determining a precession level of the rotor relative to the stator,
determining the control command for the control device from a setpoint command and from the precession level, the control command being configured to generate an overall magnetic force opposing the precession movement of the rotor so as to damp the rotor.

2. The aircraft turbine engine according to claim 1, wherein the correction device is configured, during operation in generator mode, to determine the control command consisting of injecting or modulating a current into only one of the power channels at a given instant, the other power channels being configured to collect currents at a given instant.

3. The aircraft turbine engine according to claim 1, wherein the correction device is configured to determine the control command consisting of successively injecting or modulating a current into a plurality of the power channels so as to generate an overall rotating magnetic force opposing the precession movement over time.

4. The aircraft turbine engine according to claim 1, wherein the correction device is configured to determine the control command consisting of injecting or modulating a current according to a phase advance with respect to the precession movement of the rotor.

5. The aircraft turbine engine according to claim 1, wherein the stator comprises at least one pair of the power channels that are diametrically opposed.

6. The aircraft turbine engine according to claim 1, wherein the stator comprises at least four of the power channels angularly spaced apart by 90°.

7. The aircraft turbine engine according to claim 1, wherein the propulsion shaft is secured to a fan comprising a plurality of fan vanes, the fan being mounted in a fan casing.

8. The aircraft turbine engine according to claim 7, wherein the rotor is mounted at free ends of the fan vanes, the stator being mounted on the fan casing.

9. A method for monitoring an aircraft turbine engine comprising at least one propulsion shaft, an electric motor, a rotor that is rigidly connected to the propulsion shaft, a stator, and a control device, the method comprising:
determining a precession level of the rotor relative to the stator,
determining a control command of the control device from a setpoint command and of the precession level, the control command generating an overall magnetic force opposing the precession movement of the rotor so as to damp the rotor.

10. The monitoring method as claimed in claim 9, further comprising:
recording the overall magnetic forces generated over time, and
estimating a state of wear of the turbine engine from the overall magnetic forces recorded over time.
